(19) United States
(12) Patent Application Publication
(10) Pub. No.: US 2022/0130314 A1
(43) Pub. Date: Apr. 28, 2022

(54) METHOD FOR BRIGHTNESS COMPENSATION IN A DISPLAY, BRIGHTNESS COMPENSATION CIRCUIT, AND DISPLAY DEVICE

(71) Applicant: JADARD TECHNOLOGY INC., Shenzhen (CN)

(72) Inventors: CHIEN-SHIANG HONG, Shenzhen (CN); CHIH-CHANG CHEN, New Taipei (TW); CHOU-LIANG TSAI, New Taipei (TW); LONG CHEN, Shenzhen (CN)

(21) Appl. No.: 17/151,560

(22) Filed: Jan. 18, 2021

(30) Foreign Application Priority Data
Oct. 27, 2020 (CN) 202011168110.0

(51) Int. Cl. G09G 3/20

(52) U.S. Cl. CPC G09G 3/2003; G09G 2320/0233; G09G 2300/0452; G09G 2320/0242

(57) ABSTRACT

A method to compensate for color-shifting at the periphery of a display device inputs for processing pre-display an image for display, acquires edge pixels where color-shifting occurs, and applies compensation in terms of a gray scale value to each of the edge pixels to reduce such color-shifting. An electronic circuit applying the method and a compensated display device are also disclosed.

### FIELD

The subject matter herein generally relates to displays, specifically a method for brightness compensation, a brightness compensation circuit applying the brightness compensation method, and a display device using the brightness compensation circuit.

### BACKGROUND

The arrangement of sub-pixels in a display panel is no longer limited to a standard RGB arrangement. In the standard RGB arrangement, each pixel includes adjacent red, green, and blue sub-pixels, and each pixel can independently display a desired color. In addition, the display panel can have a non-standard sub-pixel arrangement, for example, a Pentile arrangement. In the Pentile arrangement, each pixel includes red and green sub-pixels or blue and green sub-pixels, and each pixel shares red and blue sub-pixels with one adjacent pixel. However, a display panel with the non-standard sub-pixel arrangement often has a problem of a color shift at the edge of a displayed image.

Therefore, there is room for improvement in the art.

### BRIEF DESCRIPTION OF THE DRAWINGS

Implementations of the present disclosure will now be described, by way of embodiment, with reference to the attached figures.

FIG. 1 is a flowchart of a method for brightness compensation according to an embodiment.

FIG. 2 is a schematic diagram of an arrangement of sub-pixels of a display panel according to block S1 of the method in FIG. 1.

FIG. 3 is a schematic diagram of a brightness compensation circuit according to an embodiment.

FIG. 4 is a schematic diagram of a display device using the brightness compensation circuit in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. The term “circuit” is defined as an integrated circuit (IC) with a plurality of electric elements, such as capacitors, resistors, amplifiers, and the like.

One aspect of the present disclosure provides method for applying brightness compensation in a display, which includes: inputting an image to be displayed onto the display panel, wherein the image to be displayed includes a plurality of pixels arranged in a plurality of rows and a plurality of columns, and each of the plurality of pixels includes at least three sub-pixels of different colors; acquiring a plurality of edge pixels corresponding to an edge of the image to be displayed, wherein the plurality of edge pixels are pixels that display edge information of the image to be displayed; and compensating a gray scale value of each of the plurality of edge pixels.

The method for applying brightness compensation can solve the problem of color shift at the edge of the displayed image by acquiring the edge pixels corresponding to the edge of the image to be displayed and compensating the gray scale values of the edge pixels.

Another aspect of the present disclosure provides a brightness compensation circuit applied to a display panel. The brightness compensation circuit includes an edge pixel detection unit for acquiring a plurality of edge pixels corresponding to an edge of an image to be displayed on the display panel, wherein the image to be displayed includes a plurality of pixels arranged in a plurality of rows and a plurality of columns, each of the plurality of pixels includes at least three sub-pixels of different colors, and the plurality of edge pixels are pixels that display edge information of the image to be displayed; and a compensation unit electrically connected to the edge pixel detection unit, wherein the compensation unit is configured for compensating a gray scale value of each of the plurality of edge pixels.

The brightness compensation circuit detects the edge pixels corresponding to the edge of the image to be displayed by the edge pixel detection unit and compensates the gray scale values of the edge pixels by the compensation unit, which can solve the problem of color shift at the edge of the displayed image.

Yet another aspect of the present disclosure provides a display device. The display device includes a display panel and the brightness compensation circuit electrically connected to the display panel. The brightness compensation circuit is configured for compensating brightness of an image to be displayed by the display panel.

The display device includes the brightness compensation circuit, which can also solve the problem of color shift at the edge of the displayed image.

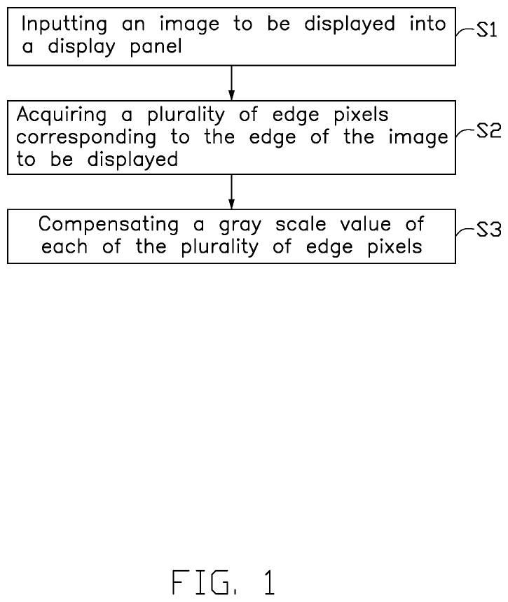

FIG. 1 shows a flowchart of a method for applying brightness compensation in a display according to an embodiment. The example method is provided by way of example, as there are a variety of ways to carry out the method. Each block shown in FIG. 1 represents one or more processes, methods, or subroutines carried out in the example method. Furthermore, the illustrated order of blocks is by example only, and the order of the blocks can be changed. Additional blocks can be added, or fewer blocks can be utilized, without departing from this disclosure. The example method can begin at block S1.

At block S1, an image to be displayed is input onto a display panel.

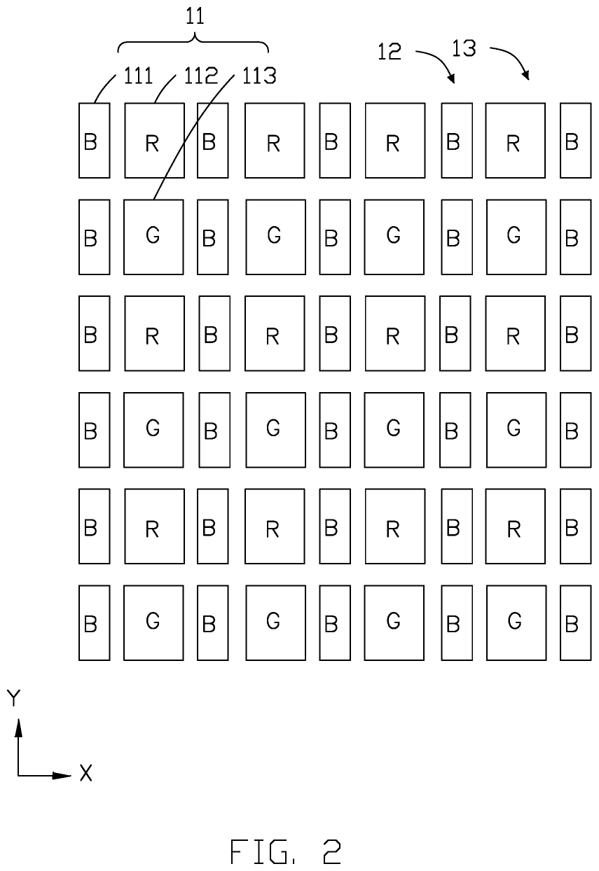

FIG. 2 shows a schematic diagram of an arrangement of sub-pixels of the display panel according to block S1 in FIG. 1. The image to be displayed utilizes a plurality of pixels 11 arranged in a plurality of rows and a plurality of columns. Each pixel 11 includes at least three sub-pixels of different colors. In block S1, the inputting of the image to be displayed includes inputting the initial gray scale value of each sub-pixel in each pixel 11.

In one embodiment, the sub-pixel arrangement in the display panel may be a Pentile arrangement or a diamond arrangement. FIG. 2 shows the Pentile arrangement. As shown in FIG. 2, a plurality of sub-pixels is arranged in a matrix. Each pixel 11 includes a first sub-pixel 111, a second sub-pixel 112, and a third sub-pixel 113. The colors of the first sub-pixel 111, the second sub-pixel 112, and the third sub-pixel 113 are blue, red, and green, respectively. The sub-pixels include first sub-pixel columns 12 and second sub-pixel columns 13 arranged alternately in a first direction X. In the first sub-pixel columns 12, only the first sub-pixels 111 are included. In each second sub-pixel column 13, each second sub-pixel 112 is alternately arranged with one third sub-pixel 113 in a second direction Y across the first direction X. Along the first direction X, if the left boundary of the displayed image is located in the first sub-pixel column 12, that is, when the first sub-pixels 111 are closer to the edge of the image than the second sub-pixels 112 and the third sub-pixels 113 are in the second sub-pixel columns 13, a color shift will occur on the left edge of displayed image. Similarly, along the first direction X, if the left boundary of the displayed image is the second sub-pixel column 13, that is, when the second sub-pixels 112 and the third sub-pixels 113 in the second sub-pixel column 13 are closer to the edge of the image than the first sub-pixels 111 are, a color shift will again occur on the left edge of the displayed image.

In other embodiments, the arrangement of the first sub-pixels 111, the second sub-pixels 112, and the third sub-pixels 113 is not limited to the arrangement described. For example, the first sub-pixel column 12 can all be the second sub-pixels 112, and it will be the first sub-pixels 111 and the third sub-pixels 113 in each of the second sub-pixel column 13 which are alternately arranged.

In one embodiment, the image to be displayed utilizes N rows and M columns of pixels 11, and both N and M are integers greater than or equal to three.

At block S2, a plurality of edge pixels corresponding to the edge of the image to be displayed is acquired.

It should be noted that the image to be displayed refers to the graphics in the display screen on the display panel, and not to the entire display image. For example, when a ring is displayed on the display panel, the ring being white and a background being black, the image to be displayed is a white ring excluding the black background.

It should also be noted that the edge pixels of the image to be displayed are pixels 11 that display edge information of the image to be displayed. For example, where the image to be displayed has N rows and M columns of pixels 11, the edge pixels may be the pixels 11 in the first row (or last row, or the first column, or last column). In addition, the edge pixels may be pixels in the background of the image to be displayed adjacent to the pixels 11 of the first row (or last row, or the first column, or last column). Still taking the white ring as an example, the pixels 11 used to display the edge information of the white ring are the pixels 11 corresponding to the edge of the image to be displayed. That is, the outer and inner circumferences of the white ring are displayed. The white ring has two edges. The two edges are concentric circles. The edge pixels corresponding to the edges of the image to be displayed include all the pixels 11 that display the information of the two concentric circles, including peripheral pixels 11 surrounding the two concentric circles on the white ring and peripheral pixels 11 surrounding the two concentric circles on the black background.

In one embodiment, block S2 includes determination of a gray scale value of each pixel 11. If the gray scale value of one pixel 11 is greater than a first gray scale threshold, the pixel 11 is defined as a high-value gray scale pixel. If the gray scale value of one pixel 11 is less than a second gray scale threshold, the pixel 11 is defined as a low-value gray scale pixel. The second gray scale threshold is less than the first gray scale threshold. The first gray level threshold and the second gray level threshold can be defined by the user. For example, if the gray scale value of a certain pixel 11 is 0 or less than a certain value, it is a low-value gray scale pixel, and if the gray scale value of a certain pixel 11 is 255 or greater than a certain value, it is a high-value gray scale pixel.

In one embodiment, the brightness compensation method further includes giving a certain marker to the high-value gray level pixel and other certain marker to the low-value gray level pixel and storing the markers for subsequent determination. The marker indicates the relative brightness of the gray scale of the pixel. For example, if a pixel 11 is defined as a low-value gray level pixel, that pixel 11 is marked as 1, and if a pixel 11 is defined as a high-value gray scale pixel, that pixel 11 is marked as 0.

Block S2 further includes detecting a distribution of gray scale values of the plurality of pixels 11. In adjacent rows of the pixels 11, if all the pixels 11 in one row are high-value gray scale pixels, and all the pixels 11 in the other row are low-value gray scale pixels, it is determined that the pixels 11 in the adjacent row are the edge pixels. In adjacent columns of the pixels 11, if all the pixels 11 in one column are high-value gray scale pixels, and all the pixels 11 in the other column are low-value gray scale pixels, it is determined that the pixels 11 in the adjacent column are the edge pixels. In the block S2, the edge pixels are obtained by analyzing the distribution of the markers. For example, in adjacent rows of the pixels 11, if the markers of the pixels 11 in one row are all 0, and the markers of the pixels 11 in the other row are all 1, it is determined that the pixels 11 in the adjacent rows suddenly change vertically from low gray level to high gray level or change vertically from high gray level to low gray level, and therefore that the pixels 11 in the adjacent row are the edge pixels. Similarly, in adjacent columns of the pixels 11, if the markers of the pixels 11 in one column are all 0, and the markers of the pixels 11 in the other column are all 1,it is determined that the pixels 11 in the adjacent columns change horizontally from low gray level to high gray level or change horizontally from high gray level to low gray level, and thus that the pixels 11 in the adjacent column are the edge pixels.

For example, when the image to be displayed is a black-and-white pattern, the pixels 11 in the first row of an upper boundary of the image to be displayed are white pixels, and the pixels 11 in the background adjacent to the pixels 11 of the first row of the upper boundary are black pixels. The gray scale values of the pixels 11 from the background to the upper boundary can be either 255 or can be zero. That is, the vertical change is from high gray scale to low gray scale. It can be determined that the pixels 11 in the first row of the upper boundary and the pixels 11 in the background adjacent to the pixels 11 in the first row of the upper boundary are edge pixels.

Similarly, when the image to be displayed is white-and-black instead of black-and-white, the pixels 11 in the first row of the upper boundary are black pixels, and the pixels 11 in the background adjacent to the pixels 11 of the first row of the upper boundary are white pixels. The gray scale values of the pixels 11 from the background to the upper boundary are herein reversed, being either zero or 255. That is, the vertical change is from low gray scale to high gray scale. It can be determined that the pixels 11 in the first row of the upper boundary and the pixels 11 in the background adjacent to the pixels 11 in the first row of the upper boundary are edge pixels. In addition, when the image to be displayed is a color pattern, the principle is similar to that of the black-and-white pattern. The difference is that low gray scale is defined as lower than a certain value greater than 0, and high gray scale is defined as higher than a certain value less than 255.

At block S3, compensation is applied to the gray scale value of each edge pixel.

In one embodiment, at block S3, the gray scale values of the sub-pixels in the edge pixels are compensated or the gray scale values of the sub-pixels in the pixels 11 that are in the same row and adjacent to the edge pixels are compensated, or the gray scale values of the sub-pixels in the pixels 11 adjacent to the same column as the edge pixels are compensated.

For example, when the image to be displayed is a black and white pattern, the pixels 11 in the first row of the upper boundary of the image to be displayed are white pixels, a row of pixels in the background adjacent to the white pixels are black pixels, and red-colored bleeding may appear at the edges of the white pixels. The gray scale values of the sub-pixels (e.g., the red sub-pixels) in the white pixels 11 in the image to be displayed can be adjusted to compensate, such as the white pixels 11 rendered as cyan, or the gray scale values of the sub-pixels in the black pixels 11 in the background can be adjusted, or the black pixels 11 rendered as reddish purple. When the display panel displays the image as compensated, the color shift phenomenon disappears.

It should be noted that the gray scale values of the sub-pixels in the edge pixels can be compensated separately, and the color shift phenomenon can be eliminated by increasing or decreasing a certain gray scale value of a certain sub-pixel in the edge pixels The color shift phenomenon can also be eliminated by compensating the gray scale values of sub-pixels in pixels that are in the same row (or the same column) and adjacent to the edge pixels, and neutralizing the brightness of the edge pixels and the adjacent pixels. In addition, not only can the gray scale values of the sub-pixels in the edge pixels be compensated, but the gray scale values of the sub-pixels in the pixels adjacent thereto can also be compensated. The degree of compensation applied to gray scale values can be obtained through extensive experimentation before the display panel leaves the factory and the values stored in a brightness compensation circuit applied to the display panel.

In addition, the image to be displayed input in block S1 has a pixel delay. After the image is calculated by the brightness compensation method, the compensated image is then output for display.

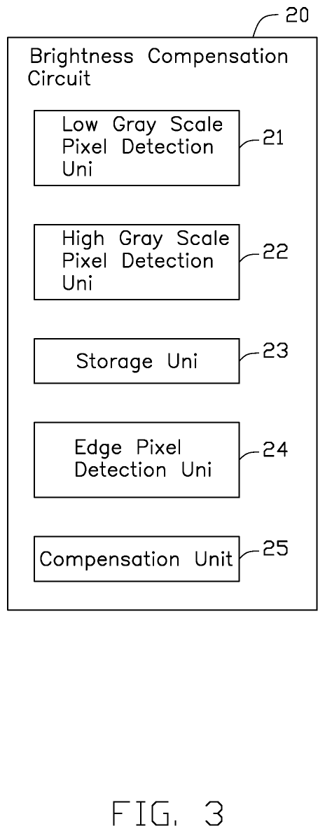

FIG. 3 shows a schematic diagram of a brightness compensation circuit 20 applied to a display panel. The image to be displayed on the display panel includes a plurality of pixels 11 arranged in a plurality of rows and a plurality of columns, and each pixel includes at least three sub-pixels of different colors.

As shown in FIG. 3, the brightness compensation circuit 20 includes a low-value gray scale pixel detection unit 21, a high-value gray scale pixel detection unit 22, a storage unit 23, an edge pixel detection unit 24, and a compensation unit 25.

The high-value gray scale pixel detection unit 22 is electrically connected to the edge pixel detection unit 24. The high-value gray scale pixel detection unit 22 can determine a gray scale value of each pixel 11 and can define each pixel 11 with the gray scale value greater than a first gray scale threshold as a high-value gray scale pixel.

The low-value gray scale pixel detection unit 21 is electrically connected to the edge pixel detection unit 24. The low-value gray scale pixel detection unit 21 determines a gray scale value of each pixel 11 and can define those with a gray scale value less than a second gray scale threshold as a low-value gray scale pixel. The second gray scale threshold is less than the first gray scale threshold. The first gray level threshold and the second gray level threshold can be defined by the user. In addition, the high-value gray scale pixel detection unit 22 is further configured for giving a marker to the high-value gray scale pixel, and the low-value gray scale pixel detection unit 21 is further configured for giving a marker to the low-value gray scale pixel.

The respective markers for high-value and low-value gray scale pixels low-value gray scale pixel are stored in the storage unit 23. The edge pixel detection unit 24 is configured for analyzing a distribution of the markers to establish edge pixels.

The storage unit 23 is electrically connected to the high-value gray scale pixel detection unit 22, the low-value gray scale pixel detection unit 21, and the edge pixel detection unit 24. The storage unit 23 is configured for storing the markers allocated by the high-value gray scale pixel detection unit 22 and the low-value gray scale pixel detection unit 21 of the pixel 11 in the image to be displayed, for the edge pixel detection unit 24 to determine, and then obtain the edge pixels corresponding to the edge of the image to be displayed.

The edge pixel detection unit 24 obtains the edge pixels by detecting a gray scale value distribution (e.g., a distribution of markers) of the plurality of pixels 11. In adjacent rows of the pixels 11, if the pixels 11 in one row are all high-value gray scale pixels, and the pixels 11 in the other row are all low-value gray scale pixels, the edge pixel detection unit 24 determines that the pixels 11 in one of the adjacent rows are the edge pixels. In adjacent columns of the pixels 11, if the pixels 11 in one column are all high-value gray scale pixels, and the pixels 11 in the other column are all low-value gray scale pixels, the edge pixel detection unit 24 determines that one the pixels 11 in one of the adjacent columns are the edge pixels. That is, the edge pixel detection unit 24 is configured for determining distribution characteristics of the gray scale values of all the pixels 11 in the image to be displayed and determining whether the gray scale values of all the pixels 11 change horizontally or vertically from high gray scale to low gray scale, or horizontally or vertically from low gray scale to high gray scale. In addition, the edge pixel detection unit 24 is further configured for outputting a judgment result to the compensation unit 25 for compensation.

The compensation unit 25 is electrically connected to the edge pixel detection unit 24. The compensation unit 25 receives the judgment result of the edge pixel detection unit 24 and is configured for compensating the gray scale value of each edge pixel.

In one embodiment, the compensation unit 25 is configured for compensating the gray scale values of the sub-pixels in the edge pixels, or to compensating the gray scale values of the sub-pixels in the pixels 11 that are in the same row and adjacent to the edge pixels or compensating the gray scale values of the sub-pixels in the pixels 11 that are in the same column and adjacent to the edge pixels. The gray scale value is compensated or the gray scale value of the sub-pixel in the pixel 11 adjacent to and in the same column as the edge pixel is compensated. A compensation value can be adjusted according to the gray scale value of the sub-pixels.

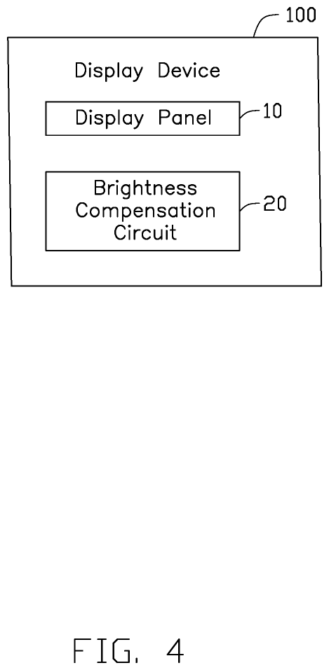

FIG. 4 shows a schematic diagram of a display device 100 according to an embodiment. The display device 100 includes a display panel 10 and the brightness compensation circuit 20. The brightness compensation circuit 20 is electrically connected to the display panel 10 and is configured for compensating brightness of the image to be displayed on the display panel 10.

In one embodiment, the display panel 10 is an organic light-emitting diode (OLED) display panel, and an arrangement of the sub-pixels of the display panel is a Pentile arrangement or a diamond arrangement, each of the pixels includes a red sub-pixel and a green sub-pixel, or a blue sub-pixel and a green sub-pixel, and each of the pixels shares the red sub-pixel and blue sub-pixel with one adjacent pixel. In another embodiment, the display panel 10 may also be a liquid crystal display (LCD) panel or micro light-emitting diode (Micro LED) display panel, and an arrangement of the sub-pixels of the display panel is a Pentile arrangement or a diamond arrangement, each of the pixels includes a red sub-pixel and a green sub-pixel, or a blue sub-pixel and a green sub-pixel, and each of the pixels shares the red sub-pixel and blue sub-pixel with one adjacent pixel.

In another embodiment, the display panel 10 may be an OLED display panel, an LCD panel, or a Micro LED display panel, and an arrangement of the sub-pixels of the display panel is standard RGB arrangement, each of the plurality of pixels includes a red sub-pixel, a green sub-pixel, and a blue sub-pixel, and each of the plurality of pixels independently displays a desired color. The display panel 10 with the standard RGB arrangement is less likely to have color shifts at the edges of the image when displaying images, but it can also use the brightness compensation method in the embodiments of the present disclosure to solve color shift. In one embodiment, the display device 100 is a product such as a tablet computer or a mobile phone.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A method for applying brightness compensation in a display, comprising:
inputting an image to be displayed onto the display panel, wherein the image to be displayed comprises a plurality of pixels arranged in a plurality of rows and a plurality of columns, and each of the plurality of pixels comprises at least three sub-pixels of different colors;
acquiring a plurality of edge pixels corresponding to an edge of the image to be displayed, wherein the plurality of edge pixels are pixels that display edge information of the image to be displayed; and
compensating a gray scale value of each of the plurality of edge pixels.

2. The method for applying brightness compensation of claim 1, wherein acquiring the plurality of edge pixels corresponding to the edge of the image to be displayed comprises:
judging a gray scale value of each of the plurality of pixels, defining each of the plurality of pixels with the gray scale value greater than a first gray scale threshold as a high-value gray scale pixel, and defining each of the plurality of pixels with the gray scale value less than a second gray scale threshold as a low-value gray scale pixel, wherein the second gray scale threshold is less than the first gray scale threshold; and
detecting a distribution of gray scale values the plurality of pixels, wherein if the pixels in one row are all high-value gray scale pixels and the pixels in the other row are all low-value gray scale pixels in adjacent rows of the plurality of pixels, it is determined that the pixels in one of the adjacent rows are the edge pixels; if the pixels in one column are all high-value gray scale pixels and the pixels in the other column are all low-value gray scale pixels in adjacent columns of the plurality of pixels, it is determined that the pixels in one of the adjacent columns are the edge pixels.

3. The method for applying brightness compensation of claim 1, wherein compensating the gray scale value of each of the plurality of edge pixels comprises:
compensating the gray scale values of the sub-pixels in the plurality of edge pixels or compensating the gray scale values of the sub-pixels in the pixels that are in the same row and adjacent to the plurality of edge pixels or compensating the gray scale values of the sub-pixels in the pixels that are in the same column and adjacent to the plurality of edge pixels.

4. The method for applying brightness compensation of claim 2, further comprising giving a certain marker to the high-value gray scale pixel and other certain marker to the low-value gray scale pixel, wherein detecting the distribution of gray scale values of the plurality of pixels comprises analyzing a distribution of the markers to obtain the edge pixels.

5. A brightness compensation circuit applied to a display panel, comprising:
an edge pixel detection unit for acquiring a plurality of edge pixels corresponding to an edge of an image to be displayed on the display panel, wherein the image to be displayed comprises a plurality of pixels arranged in a plurality of rows and a plurality of columns, each of the plurality of pixels comprises at least three sub-pixels of different colors, and the plurality of edge pixels are pixels that display edge information of the image to be displayed; and
a compensation unit electrically connected to the edge pixel detection unit, wherein the compensation unit is configured for compensating a gray scale value of each of the plurality of edge pixels.

6. The brightness compensation circuit of claim 5, further comprising:
a high-value gray scale pixel detection unit electrically connected to the edge pixel detection unit, wherein the high-value gray scale pixel detection unit is configured for judging a gray scale value of each of the plurality of pixels, and defining each of the plurality of pixels with the gray scale value greater than a first gray scale threshold as a high-value gray scale pixel; and
a low-value gray scale pixel detection unit electrically connected to the edge pixel detection unit, wherein the low-value gray scale pixel detection unit is configured for judging a gray scale value of each of the plurality of pixels and defining each of the plurality of pixels with the gray scale value less than a second gray scale threshold as a low-value gray scale pixel, and the second gray scale threshold is less than the first gray scale threshold.

7. The brightness compensation circuit of claim 5, wherein the edge pixel detection unit acquires the plurality of edge pixels by detecting a distribution of gray scale values of the plurality of pixels;
wherein in adjacent rows of the plurality of pixels, if the pixels in one row are all high-value gray scale pixels and the pixels in the other row are all low-value gray scale pixels, the edge pixel detection unit determines that the pixels in one of the adjacent rows are the edge pixels; in adjacent columns of the plurality of pixels, if the pixels in one column are all high-value gray scale pixels and the pixels in the other column are all low-value gray scale pixels, the edge pixel detection unit determines that the pixels in one of the adjacent columns are the edge pixels.

8. The brightness compensation circuit of claim 5, wherein the compensation unit is configured for compensating the gray scale values of the sub-pixels in the plurality of edge pixels or compensating the gray scale values of the sub-pixels in the pixels that are in the same row and adjacent to the plurality of edge pixels or compensating the gray scale values of the sub-pixels in the pixels that are in the same column and adjacent to the plurality of edge pixels.

9. The brightness compensation circuit of claim 6, further comprising a storage unit electrically connected to the high-value gray scale pixel detection unit, the low-value gray scale pixel detection unit, and the edge pixel detection unit;
wherein the high-value gray scale pixel detection unit is further configured for giving a certain marker to the high-value gray scale pixel, and the low-value gray scale pixel detection unit is further configured for giving other certain marker to the low-value gray scale pixel;
wherein the storage unit is configured for storing the makers of the high-value gray scale pixels and the makers of the low-value gray scale pixels, and the edge pixel detection unit is configured for analyzing a distribution of the makers to obtain the edge pixels.

10. A display device comprising:
a display panel; and
a brightness compensation circuit electrically connected to the display panel; the brightness compensation circuit being configured for compensating brightness of an image to be displayed by the display panel;
wherein the brightness compensation circuit comprises:
an edge pixel detection unit for acquiring a plurality of edge pixels corresponding to an edge of the image to be displayed on the display panel, wherein the image to be displayed comprises a plurality of pixels arranged in a plurality of rows and a plurality of columns, each of the plurality of pixels comprises at least three sub-pixels of different colors, and the plurality of edge pixels are pixels that display edge information of the image to be displayed; and
a compensation unit electrically connected to the edge pixel detection unit, wherein the compensation unit is configured for compensating a gray scale value of each of the plurality of edge pixels.

11. The display device of claim 10, wherein the brightness compensation circuit further comprises:
a high-value gray scale pixel detection unit electrically connected to the edge pixel detection unit, wherein the high-value gray scale pixel detection unit is configured for judging a gray scale value of each of the plurality of pixels, and defining each of the plurality of pixels with the gray scale value greater than a first gray scale threshold as a high-value gray scale pixel; and
a low-value gray scale pixel detection unit electrically connected to the edge pixel detection unit, wherein the low-value gray scale pixel detection unit is configured for judging a gray scale value of each of the plurality of pixels and defining each of the plurality of pixels with the gray scale value less than a second gray scale threshold as a low-value gray scale pixel, and the second gray scale threshold is less than the first gray scale threshold.

12. The display device of claim 10, wherein the edge pixel detection unit acquires the plurality of edge pixels by detecting a gray scale value distribution of the plurality of pixels;
wherein if the pixels in one row are all high-value gray scale pixels and the pixels in the other row are all low-value gray scale pixels in adjacent rows of the plurality of pixels, the edge pixel detection unit determines that the pixels in one of the adjacent rows are the edge pixels; if the pixels in one column are all high-value gray scale pixels and the pixels in the other column are all low-value gray scale pixels in adjacent columns of the plurality of pixels, the edge pixel detection unit determines that the pixels in one of the adjacent columns are the edge pixels.

13. The display device of claim 10, wherein the compensation unit is configured for compensating the gray scale values of the sub-pixels in the plurality of edge pixels or compensating the gray scale values of the sub-pixels in the pixels that are in the same row and adjacent to the plurality of edge pixels or compensating the gray scale values of the sub-pixels in the pixels that are in the same column and adjacent to the plurality of edge pixels.

14. The display device of claim 11, wherein the brightness compensation circuit further comprises: a storage unit electrically connected to the high-value gray scale pixel detection unit, the low-value gray scale pixel detection unit, and the edge pixel detection unit;
wherein the high-value gray scale pixel detection unit is further configured for giving a certain marker to the high-value gray scale pixel, and the low-value gray scale pixel detection unit is further configured for giving other certain marker to the low-value gray scale pixel;
wherein the storage unit is configured for storing the makers of the high-value gray scale pixels and the makers of the low-value gray scale pixels, and the edge pixel detection unit is configured for analyzing a distribution of the makers to obtain the edge pixels.

15. The display device of claim 10, wherein the display panel is an organic light-emitting diode display panel, a liquid crystal display panel, or a micro light-emitting diode display panel.

16. The display device of claim 10, wherein an arrangement of the sub-pixels of the display panel is a Pentile arrangement or a diamond arrangement, each of the plurality of pixels comprises a red sub-pixel and a green sub-pixel, or a blue sub-pixel and a green sub-pixel, and each of the plurality of pixels shares the red sub-pixel and blue sub-pixel with one adjacent pixel.
